(19) United States
(12) Patent Application Publication
(10) Pub. No.: US 2023/0245065 A1
(43) Pub. Date: Aug. 3, 2023

(54) SYSTEM AND METHOD FOR GENERATING COST ESTIMATION FOR DAMAGE RESTORATION

(71) Applicant: The Solutions Company, LLC, Cocoa Beach, FL (US)

(72) Inventor: Thomas McGuire, Cocoa Beach, FL (US)

(73) Assignee: The Solutions Company, LLC, Cocoa Beach, FL (US)

(21) Appl. No.: 18/194,898

(22) Filed: Apr. 3, 2023

Related U.S. Application Data
(63) Continuation-in-part of application No. 17/242,680, filed on Apr. 28, 2021.
(60) Provisional application No. 63/017,200, filed on Apr. 29, 2020.

(51) Int. Cl. G06Q 10/10; G06Q 10/0631

(52) U.S. Cl. CPC G06Q 10/103; G06Q 10/063118; G06Q 10/06313

(57) ABSTRACT

Methods and apparatus for a budget and reserve estimation system for restoring property damage include a remotely accessible content server and storage device for storing and processing project data. Individual project data may be uploaded to the content server via a dashboard or graphical user interface displayed on a user device. Project data may then be processed by the content server to generate individualized budget and reserve cost estimates for a property restoration project. The dashboard may allow the user to review a default set of parameters based on generalized project information. The dashboard may then allow the user to enter customized project conditions to obtain more accurate forecasts of the expected production rate for each type of laborer to generate more accurate and individualized budget and reserve cost estimates.

### CROSS-REFERENCES TO RELATED APPLICATIONS

This application is a continuation-in-part of U.S. patent application Ser. No. 17/242,680, filed on Apr. 28, 2021, claims the benefit of U.S. Provisional Patent Application No. 63/017,200, filed Apr. 29, 2020, and incorporates the disclosure of the application by reference. To the extent that the present disclosure conflicts with any referenced application, however, the present disclosure is to be given priority.

### BACKGROUND OF THE TECHNOLOGY

Preparing estimates of repair and restoration for property damage is a complex and difficult task. The type of damage being repaired often requires a specific set of requirements. For example, smoke and water damage after a fire may require more intensive remediation measures than would be required from damage resulting from a minor flooding event. Similarly, buildings or commercial spaces that are exposed to hazardous materials may require specialized equipment and personnel. Each recovery and restoration of property damage project may have unique requirements that may not easily transfer over from prior projects increasing the difficulty to generate a budget estimation.

Traditionally the estimation process requires obtaining staffing requirements, obtaining estimates from outside vendors, renting equipment, and estimating subsistence requirements associated with the labor requirements. Each step can be a long process and may create delays in generating the actual estimate for the project as a whole. Attempts to make the estimation process more efficient may involve the use of spreadsheets and reviewing past estimates, but true efficiencies are difficult to achieve. For example, existing systems are unable to account for the production rate of laborers and how that rate may change based on a specific type of facility, the extent and type of the damage being repaired and/or remediated. Instead, existing systems are based on unchanging estimates of labor production rates. This limitation creates difficulties in obtaining accurate estimates of the amount of staff and type of staff required to fulfill a given project.

### SUMMARY OF THE TECHNOLOGY

Methods and apparatus for a project budget and insurance loss reserve estimation system for restoring property damage include a remotely accessible content server and storage device for storing and processing project data. Individual project data may be uploaded to the content server via a dashboard or graphical user interface displayed on a user device. Project data may then be processed by the content server to generate individualized budget and reserve cost estimates for a specific property restoration project. The dashboard may allow the user to review a default set of parameters based on generalized project information as per the user's publicized labor rates. The dashboard may then allow the user to enter customized project conditions to obtain more accurate forecasts of the expected production rate for each type of laborer to generate more accurate and individualized project budget and insurance loss reserve cost estimates.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 representatively illustrates a block diagram of an exemplary environment for an internet-based budget and reserve estimation system in accordance with an exemplary embodiment of the present technology;

FIG. 2 representatively illustrates a process flow chart for the internet-based budget and reserve estimation system in accordance with an exemplary embodiment of the present technology;

FIG. 3 representatively illustrates a graphical user interface for entering initial project data in accordance with an exemplary embodiment of the present technology;

FIG. 4 representatively illustrates a graphical user interface for entering a preliminary set of project data and a set of selectable mitigation levels in accordance with an exemplary embodiment of the present technology;

FIG. 5 representatively illustrates a data entry window for adjusting an expected production rate in accordance with an exemplary embodiment of the present technology;

FIG. 6 representatively illustrates a set of estimated labor costs in accordance with an exemplary embodiment of the present technology;

FIG. 7 representatively illustrates a set of customized estimated labor costs in accordance with an exemplary embodiment of the present technology;

FIG. 8 representatively illustrates a set of estimated overhead costs in accordance with an exemplary embodiment of the present technology;

FIG. 9 representatively illustrates a vendor window in accordance with an exemplary embodiment of the present technology;

FIG. 10 representatively illustrates a set of specialty services in accordance with an exemplary embodiment of the present technology;

FIG. 11 representatively illustrates a set of reconstruction service in accordance with an exemplary embodiment of the present technology; and

FIG. 12 representatively illustrates a completed project estimate in accordance with an exemplary embodiment of the present technology.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

### DETAILED DESCRIPTION OF EXEMPLARY EMBODIMENTS

The present technology may be described in terms of functional block components and various process steps. Such functional blocks may be realized by any number of components configured to perform the specified functions and achieve the various results. For example, the present technology may employ various types of computing platforms and memory storage systems configured to operate over various types of communication networks, which may carry out a variety of operations suited to processing various types of intelligence information. In addition, the embodiments described are merely exemplary applications for the technology. Further, the present technology may employ any number of conventional techniques for data storage and retrieval, receiving data, reporting, or otherwise managing data.

Systems and methods for generating a cost estimation for a damage restoration project according to various aspects of the present technology may operate in conjunction with any type of computing system, application server, data storage system, or the like. Various representative implementations of the present technology may be applied to various systems for estimating project costs that require estimates of labor production rates, supplies, materials, company owned equipment, and other costs such as outside contractors, and remediation requirements, used in connection with the repair and restoration of buildings, facilities, or other structures or spaces.

A user device may comprise conventional computing components, such as a processor, a local memory such as RAM, long term memory such as a hard disk, solid-state drive, or electronic non-volatile computer storage medium, a network adaptor, and any number of input and/or output devices such as a keyboard, mouse, monitor, touch screen, microphone, speaker, motion sensor, orientation sensor, light sensor, and the like. The various memories of the user device may facilitate the storage of one or more computer instructions, such as a software routine and/or software program, which may be executable by the processor to perform one or more methods, processes, and/or steps of the disclosed technology. The user device may comprise any suitable device or system such as: a personal computer, server, mobile phone, smart phone, tablet computer, kiosk, portable computer, and the like.

Further, databases, systems, and/or components of the present technology may comprise any combination of databases, systems, and/or components at a single location or at multiple locations. Each database, system, and/or component of the present technology may comprise any suitable security features, such as one or more firewalls, access codes, encryption, de-encryption, compression, decompression, and/or the like. Systems and methods according to the present technology may comprise one or more databases configured to store data according to the present technology. In some embodiments, data may be shared and/or linked among the various databases and servers. The one or more databases may be implemented using database schemes such as IBM DB2, Oracle, MySQL, and/or Microsoft SQL Server, or any other database scheme, whether now known or later developed. Transferring data to and from the one or more databases may be accomplished using a communicative coupling, for example a network connection to the Internet or a local area network (LAN).

The present technology may be embodied as a method, a system, a device, and/or a computer program product. Accordingly, the present technology may take the form of an entirely software embodiment, an entirely hardware embodiment, or an embodiment combining aspects of both software and hardware. Furthermore, the present technology may take the form of a set of instructions, such as a computer program product, for causing a processor and/or computing device to improve the functionality of the system, stored on a non-transitory computer-readable storage medium having computer-readable program code embodied in the storage medium. Any suitable computer-readable storage medium may be utilized, including, but not limited to, hard disk drive, CD-ROM, optical storage devices, magnetic storage devices, solid-state devices, USB memory devices, any appropriate volatile or non-volatile memory system, and the like or any combination thereof. The present technology may take the form of a downloadable and/or cloud-based non-downloadable computer program product, and/or a software as a service (SAAS) product that is accessed by the user device over a network.

In addition, the present technology may employ any number of conventional techniques for data transmission, signaling, data processing, network control, and the like. Computing devices according to various aspects of the present technology may communicate with each other by one or more telecommunication networks. The telecommunication network may comprise a collection of terminal nodes, links, and any intermediate nodes which are connected to enable communication (including transfer of data) at a distance between the terminal nodes. In some embodiments, a terminal node may comprise a computing device. The telecommunication network may comprise any suitable communication system, such as the Internet, an intranet, an extranet, WAN, LAN, Bluetooth, satellite communications, cellular radio network, wireless network, telephone network, cable network, and the like. Moreover, computing devices according to various aspects of the present technology may communicate over the telecommunication network using TCP/IP, HTTP, HTTPS, FTP, IPX, AppleTalk, IP-6, NetBIOS, OSI, and/or any number of existing or future protocols. The telecommunication network may be simply referred to as a network.

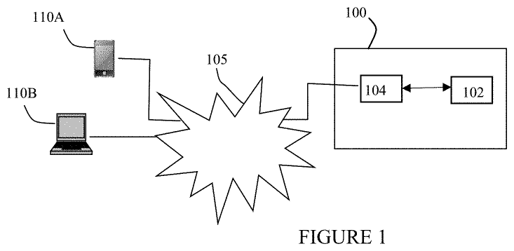

Referring now to FIG. 1, a cost estimation system 100 may comprise a network-based non-transitory storage device 102 and a content server 104 configured to communicate with one or more user devices 110A, 110B over a communication network 105. The network-based non-transitory storage device 102 may comprise a set of project data and a project library. The network-based non-transitory storage device 102 may also be configured to store individual project data for one or more user project estimates to allow a user to access past project estimates.

The user device 110 comprise any suitable device for interfacing with the content server 104, such as a mobile device 110A like a smartphone or tablet computing device or a personal computer 110B. The user device 110 may run applications locally or remotely such that the user device 110 operates as a terminal, or applications may run cooperatively between the user device 110 and other systems, such as the user device 110 and the content server 104 operating in a client-server configuration.

In various embodiments, the network-based non-transitory storage device 102 may comprise any hardware, software, and/or database component capable of storing and maintaining data. For example, the network-based non-transitory storage device 102 may comprise a database, data structure, memory component, or the like. The network-based non-transitory storage device 102 may comprise any suitable non-transitory memory known in the art, such as, an internal memory (e.g., random access memory (RAM), read-only memory (ROM), solid state drive (SSD), etc.), removable memory (e.g., an SD card, an xD card, a CompactFlash card, etc.), or the like.

The content server 104 may be configured to generate a dashboard or other graphical user interface (GUI) comprising one or more data entry fields for display on the user device 110 to allow a user to interact with the cost estimation system 100 and enter project specific data. The data entry fields may be displayed in the GUI in a manner to converts database fields into easily understandable options and data fields. Individual data fields may also include elements such as pop-up windows or sub-windows directed to providing a user with more detailed descriptions of data entry options or descriptions.

The content server 104 may also access the network-based non-transitory storage device 102 to use information from the project library to generate a user cost estimation based on data received via the dashboard for a given user project. Project data entered via the dashboard may be uploaded in real time to the content server 104 so that the entered project data is processed in real-time. The content server 104 may use the entered data collected to generate a unique, immediate, and specifically targeted project estimation that instantly responds to entered data, changes made to previously entered data, or user adjustments to default values from the project library.

The project library may store a set of general project data that may be used to generate a custom user project estimation. The set of general project data may comprise any suitable criteria corresponding to a damage restoration project such as labor costs, material costs, specialty services and associated costs, and expected staffing requirements, and labor production rates. For example, the project library may store a set of default labor production rate cost estimates corresponding to a set of user selectable predetermined mitigation levels. The content server 104 may use a given production rate cost estimate to generate an initial project estimate for a user project based on data entered by the user.

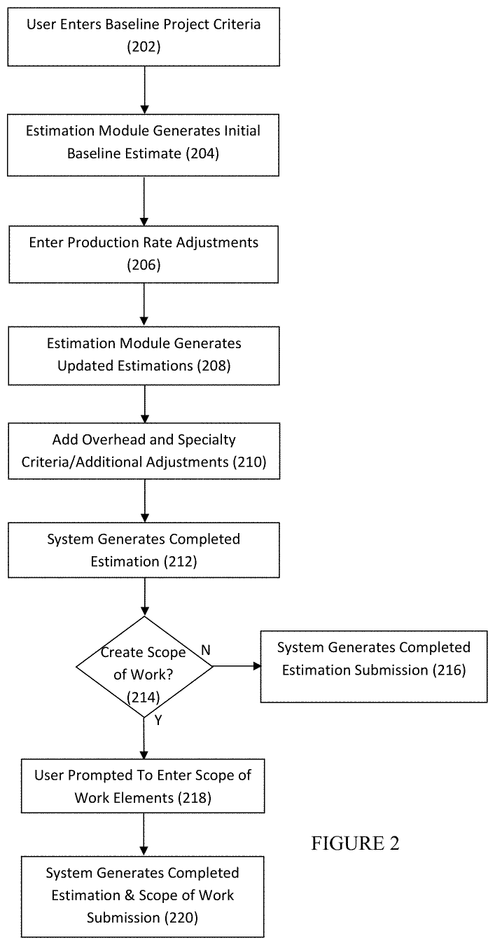

Referring now to FIG. 2, to generate a new budget and reserve estimate for a recovery and restoration of property damage project a user device 110 may access the content server 104 via the GUI and enter a preliminary set of project data according to a set of predetermined project requirement data entry fields shown on the GUI. The preliminary set of project data may comprise any suitable criteria such as project location, building/facility size, level of remediation or necessary restoration, and number of calendar days to complete the project (202). After the preliminary requirements have been identified, the content server 104 may calculate an initial baseline estimation and required staffing labor data for review by the user (204). Required labor data may include various factors such as an initially calculated number of workers required for the recovery and restoration of property damage project and a predicted labor cost based on the expected number of workers, a predetermined hourly cost for each worker, and an expected production rate for each worker.

The baseline labor calculations may be adjusted, modified, or otherwise refined by the user by adjusting or adding additional criteria such as expected overtime requirements or labor production rate adjustments that may be required according to a particular project (206). For example, projects that require union labor may have a higher labor rate or limitations on allowable overtime than a project that does not require union workers. Alternatively, more intense levels of remediation may reduce the expected production rate for laborers. Similarly, unique conditions associated with a given facility, location, or environmental conditions may also impact the production rate. Accordingly, the GUI may be configured to guide a user through entering specific project adjustments to obtain a more accurate production rate as compared to the initially generated baseline production rate associated with a selected mitigation level. The content server 104 may provide an updated estimate for labor costs based on any changes made by the user and present the updated estimation to the user for review (208).

Once a user has entered details for the estimated labor requirements for a project, the content server 104 may prompt the user to enter, via the GUI, additional project details relating to overhead costs for a project such as necessary supplies and materials, equipment rentals, required vendors or sub-contractors, purchased supplies, and potential travel related costs (210). The user may also be prompted to include additional criteria such as specialty services and reconstruction data that are unique to a given project.

The content server 104 may be configured to process all of the user provided data and generate a final project budgetary and labor estimate (212). The generated estimate may be broken down into categories to provide a clear understanding of the generated estimate and the corresponding cost of each category. Each finalized estimate may be saved by the system to improve and preserve historical knowledge of requirements and completed projects that may be used to further refine the estimation module on a continuous basis for subsequent projects.

In some embodiments, the content server 104 may be further configured to generate a scope of work document following the completion of the project estimate. For example, upon completion, the content server 104 may display a separate tab on the GUI that may be selected by the user if a scope of work is desired (214). If the user opts to not include a scope of work, then the content server 104 may complete the project budgetary and labor estimate and save it to the project library 102 (216). If the user opts to generate a scope of work, then the content server 104 may prompt the user to select a set of scope of work elements (218). Once selected, the content server 104 may then generate the completed estimation package that includes both the project budgetary and labor estimate and the project scope of work that may then be used as a bid submission package (220).

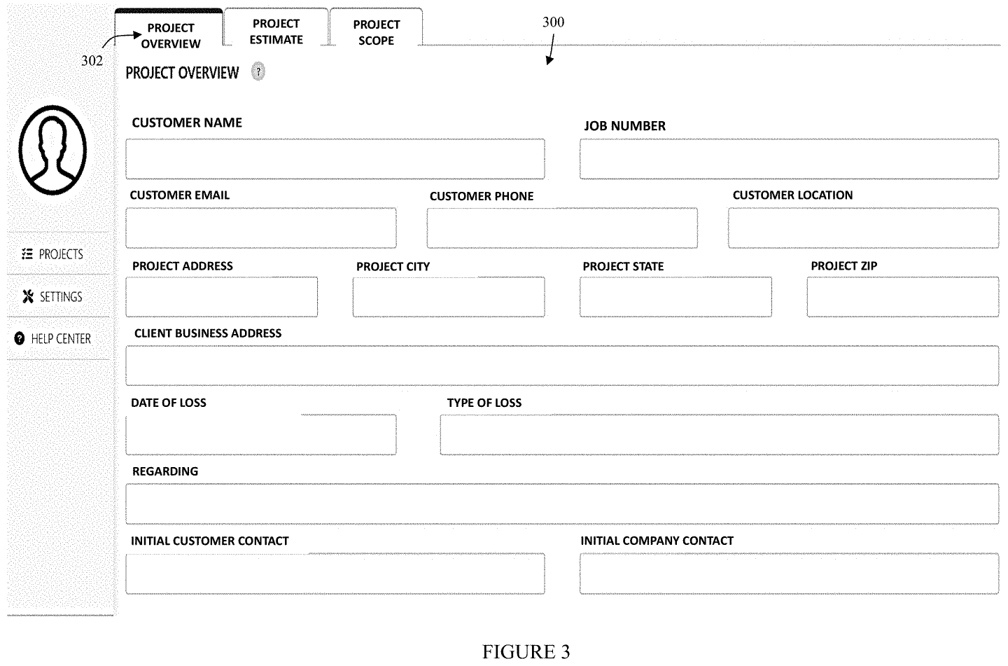

Referring now to FIGS. 2 and 3, when the user device 110 accesses the content server 104, a GUI 300 may be displayed on the user device 110A, 110B with one or more data entry fields or regions. For example, when creating a new project estimate (202), the GUI may display a project overview tab 302 and a project description data box 304 for receiving generalized project information such as client details and project location.

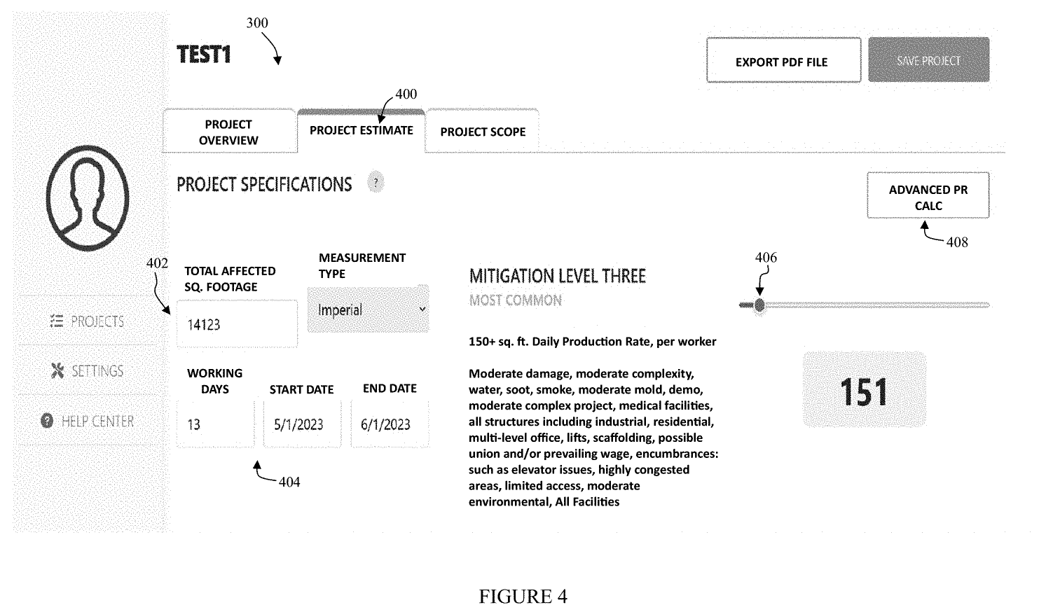

Referring now to FIG. 4, the GUI 300 may include a project estimate tab 400 that opens a window to allow the user to enter more detailed information about the project to generate the preliminary set of project data. In one embodiment, the project estimate tab 400 may comprise data fields for the user to enter a total square footage 402 for the project and a number of calendar days 404 that the project must be completed within. This data may be immediately uploaded to the content server 104 or it may be uploaded in response to a command from the user device 110A, 110B.

The GUI 300 may also display the set of user selectable predetermined mitigation levels 406. The set of user selectable predetermined mitigation levels 406 correspond to an expected average laborer daily production rate for a predefined type of remediation. The daily production rate is the expected amount of square feet an individual laborer can be expected to remediate in a standard 8 hour shift. For example, the GUI may display a slide bar with two or more mitigation levels that the user may adjust to select the type of project for which the estimate is being generated. Each selected level may include a definition or description of the type of remediation and the expected production rate, expressed in square feet, that a laborer would be expected to complete over the course of a normal workday. Each level may comprise a different production rate differing from a minimal remediation level and higher production rate number to increasingly more difficult levels of remediation with correspondingly decreasing numbers of productions rates. For example, as shown in FIG. 4, a Level Three remediation level may comprise a production rate for each laborer of 400 square feet per day. A Level Two mitigation level may comprise an expected production rate for each laborer of 150 square feet per day. One of skill in the art will recognize that the more complex or intense that a given remediation level is, the fewer number of square feet that the laborer can complete in a given day.

After the user selects the desired mitigation level 400, the content server 104 is provided with enough information to generate a baseline estimate for the project (204). For example, in one embodiment, the content server 104 may divide the total square feet of the project by the selected production rate to determine the total number of days required to complete the project. The content server 104 may then divide the calculated number of days by the number of project days entered by the user to determine the total number of laborers needed to complete the project within the required timeframe.

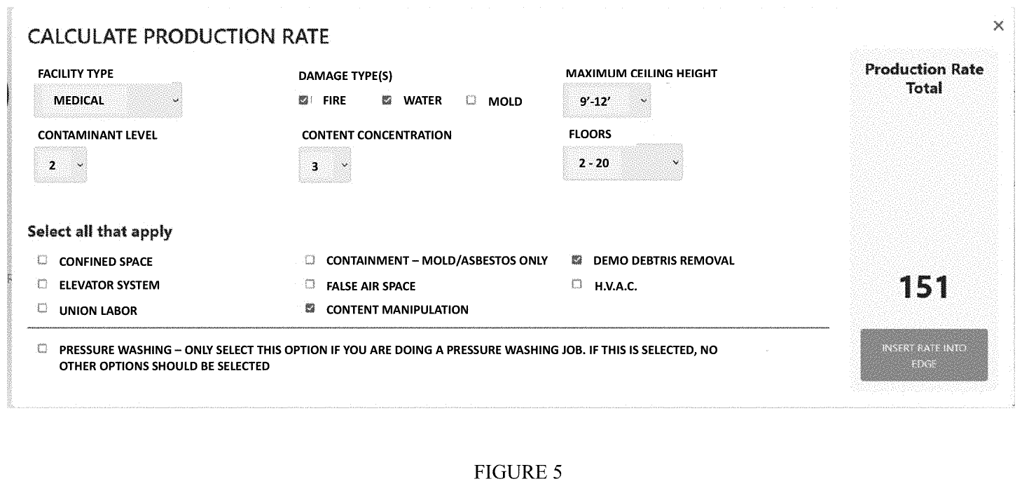

The GUI also provides the user with an option for generating a more customized production rate by. For example, by clicking on an advanced tab 408, the GUI may open a new window (see FIG. 5) that presents the user with additional adjustment options for generating a more accurate production rate. In one embodiment, options such as: a facility type for the property, wall height for the facility, a level of water damage, a level of smoke damage, a level of mold damage, and a number of floors for the facility may be displayed. Each option may include a drop down box or data entry field that allows the user to enter project specific data for each field. Each additional data entry will adjust the baseline expected production rate by an amount to create an updated production rate that is more reflective of the individualized project as compared to a generalized project of similar scope. This updated production rate is then used to adjust the baseline estimate for the project (208).

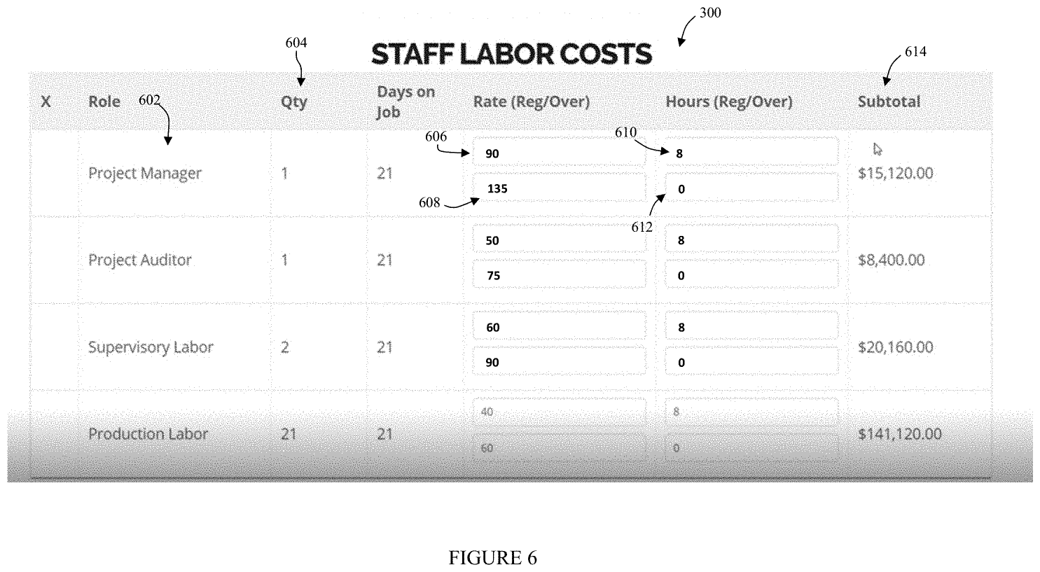

The content server 104 may be further configured to determine additional labor requirements for the project. In one embodiment, the project library may comprise a default set of figures for additional labor requirements such as project supervisors, project managers, and project auditors. For example, the default set of additional labor requirements may automatically add one project supervisor for every 10 required laborers and one project manager and one auditor per project. Once the total labor requirement is determined, the content server 104 may apply a set of default labor pay rates saved in the project library to determine an initial labor cost estimate. Referring now to FIG. 6, the content server 104 may display the calculated labor requirements on the GUI 300 and show the total number of expected laborers 602 by type and number required 604. The set of labor pay rates may also be shown on the GUI 300. For example, a base pay rate 606 and an overtime pay rate 608 for each laborer type. The GUI 300 may also display a default number of work hours per day for each laborer type broken down by regular hours 610 and overtime hours 612. Using the number of laborers required, the corresponding pay rates, and the hours per day, the content server 104 may generate cost estimates 614 for each type of laborer required to complete the project.

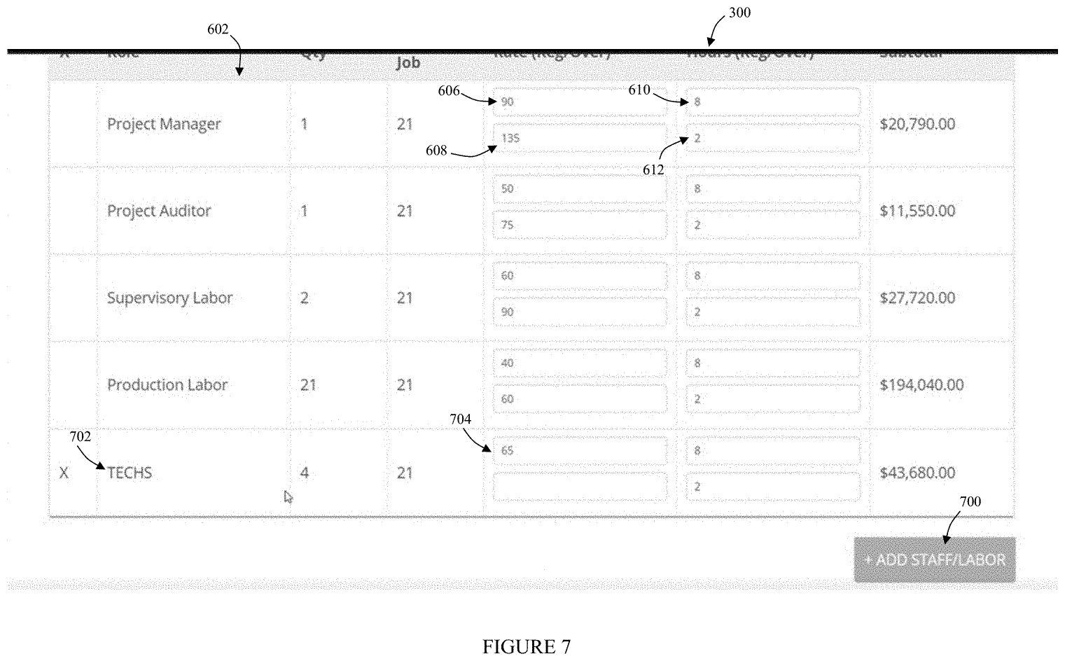

Referring now to FIGS. 2 and 7, after the initial project estimate and an estimate of required laborers is generated, the user may be able to review the projected labor figures (206). The GUI may be configured to allow the user to edit any default parameters used by the content server 104. For example, the project may allow for overtime to be used and the user may enter the number of overtime hours required for each laborer type. Once the overtime data is entered, the content server 104 may update each cost estimate or adjust the number of laborers required.

The GUI may also include an option to add a laborer type that wasn't included in the initial project estimate. For example, if the user selects an Add Staff button 700, a list of additional types of laborers may be presented to the user for selection or the user may enter the name or type 702 of additional laborer required and the number required for the project. The content server 104 may then generate a corresponding labor pay rate for the selected laborer type or the user may enter a unique pay rate 704. Once received, the content server 104 may then update the initial project estimate to provide an updated estimation for the cost of labor (208).

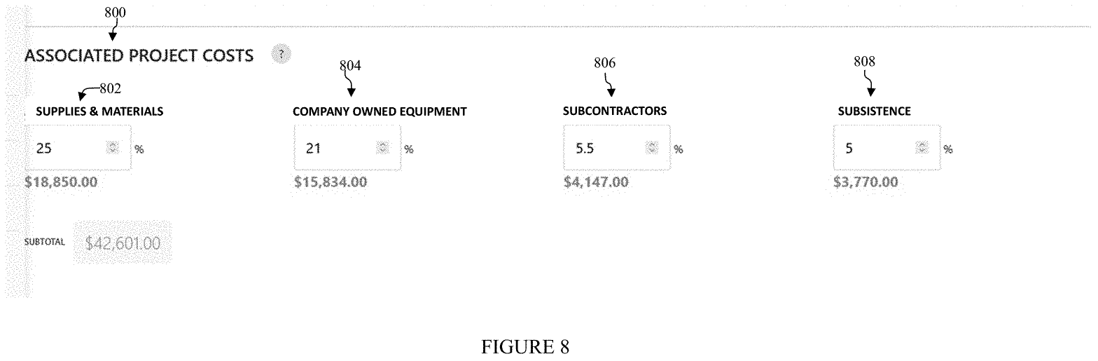

Once the expected labor requirements are set, the GUI may display to the user a set of additional project related costs such as: projected overhead; vendor requirements; specialty services; and reconstruction requirements. With reference now to FIGS. 2 and 8, the content server 104 may generate an initial set of project overhead costs 800 for factors such as: supplies 802; required equipment 804; required subcontractors 806; and labor subsistence 808. The content server 104 may determine the cost for each overhead cost based on a set value as a percentage of the calculated labor costs (210) that is saved in the project library 102. For example, supplies 802 may comprise a value of between five and thirty percent of the calculated labor costs and equipment 704 may comprise a value of between 5 and twenty-five percent of the calculated labor costs. The default percentage used may be determined or updated by the content server over 104 time as true costs for each factor changes over time. For example, the content server 104 may be configured to periodically compare the default percentage used against any variances from the value determined for more recently saved estimates or based on updated values entered into the project library 102. The value used by the content server 104 may be based on historical knowledge and be directed to alleviating the need for the user to separately obtain an estimate before beginning to enter data into the GUI thereby decreasing the amount of time required to generate the project estimate.

The content server 104 may enter a default value for each percentage, but the user may be able to adjust the value according to the requirements of the particular project being estimated. For example, if the user is aware of a reason why the default value may not be accurate for the current project, they may choose to adjust the value to reflect the changed conditions. As before, the content server 104 may update the projected costs as soon as the user makes and changes or adjustments to the default values.

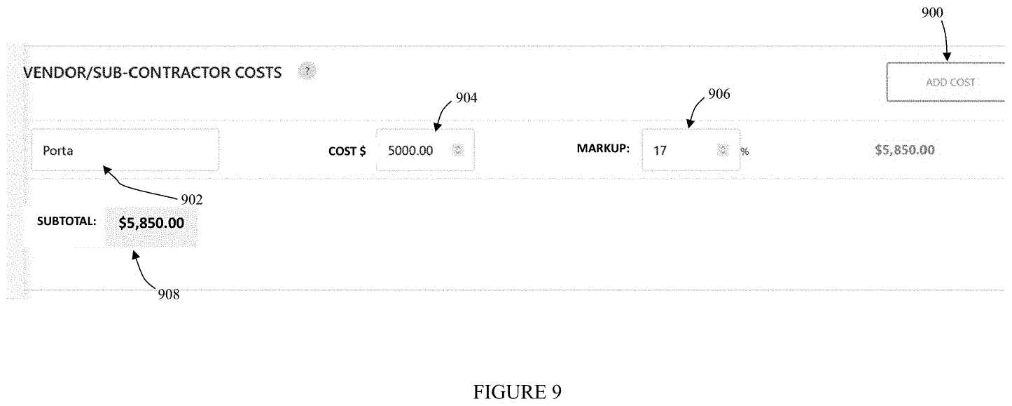

Referring now to FIG. 9, the user may also be able to customize the additional project related costs by adding in vendor costs. For example, the user may be able to select to add a vendor by selecting an Add Cost 800 option from the GUI. In response, the content server 104 may generate a line item that allows the user to either enter the name of a particular vendor 902 or select from a set of prepopulated vendor options. For example, the user may know that the current project will require the use of portable waste stations and may select that option or enter it as a custom vendor and a cost 904 for the vendor's goods or services. In response, the content server 104 may enter the vendor information into the estimate and display the results on the GUI. The user may be able to adjust the calculated vendor cost by adding in any additional markup 906 that may adjust the total vendor cost 908.

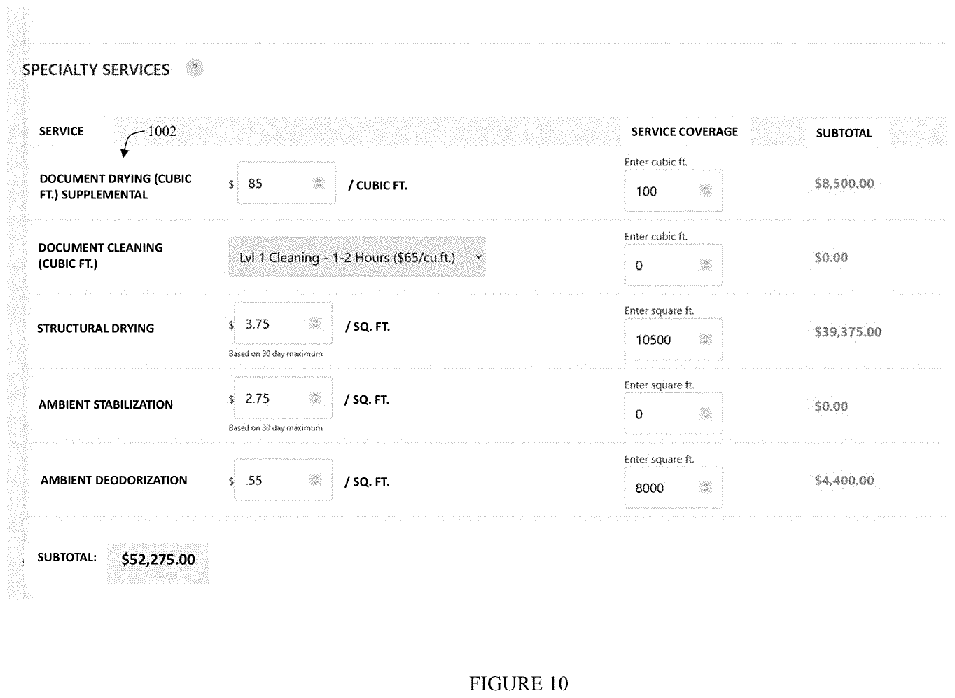

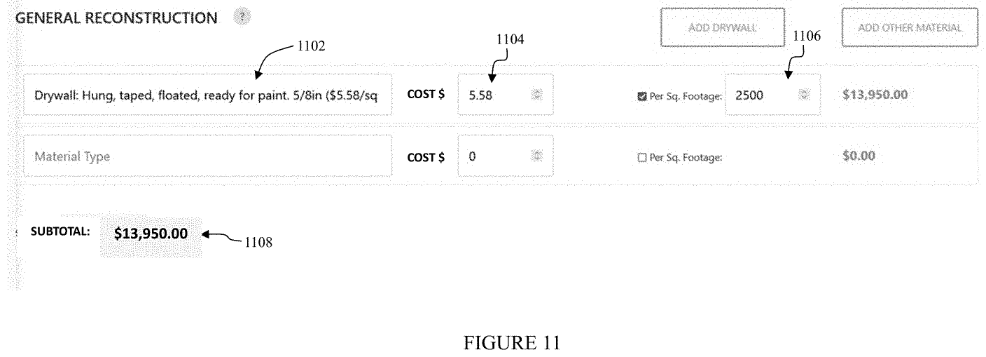

Referring now to FIG. 10, if a project requires any specialty services that are not included in the selected mitigation level 406, the user may be able to select a particular specialty service type 1002 and enter any required data relating to the service type. Once entered, the content server 104 will calculate the additional cost and add it to the project estimate. Similarly, and referring now to FIG. 11, if the project requires any restoration or reconstruction, the user may select of type of required reconstruction 1102 and enter in the associated cost 1104 and number of square feet 1106 of reconstruction required. Again, based on the data entered, the content server 104 will calculate the estimated costs for reconstruction 1108.

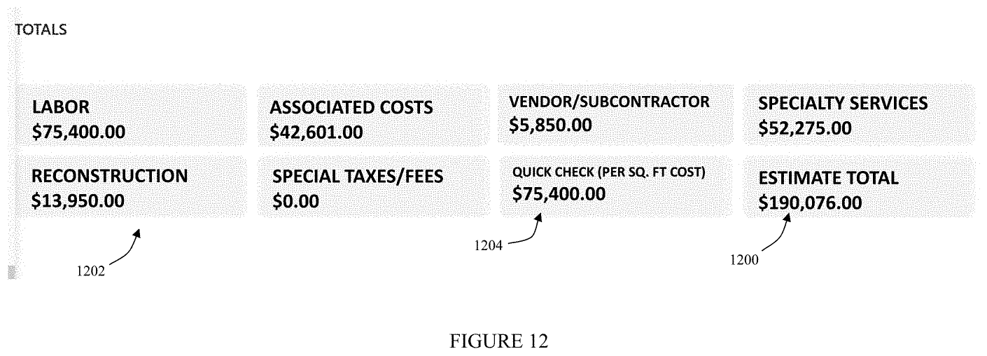

Referring now to FIG. 12, after all of the data has been entered by the user, the content server 104 will display the estimated totals for each portion of the estimate 1202 as well as the total estimate 1200. The content server 104 may also display a final estimate of the cost per square foot 1204 for the project. The user may be able to compare the newly calculated estimate of the cost per square foot 1204 for the current project estimate against the same metric for other prior projects to determine how the current estimate compares to known historical values for similar projects as a way of judging the quality of the current estimate.

As used herein, the terms “comprises,” “comprising,” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to exemplary embodiments. However, changes and modifications may be made to the exemplary embodiments without departing from the scope of the present technology. These and other changes or modifications are intended to be included within the scope of the present technology, as expressed in the following claims.

1. A method for generating a project budget and insurance loss reserve estimation for recovery and restoration of property damage to a facility, comprising:
storing a set of baseline project data in a network-based non-transitory storage device,
wherein:
the set of baseline project data includes a set of predefined mitigation levels corresponding to an amount of restoration required due to a type and extent of suffered damage; and
each predefined mitigation level corresponds to an expected production rate of a laborer based on historical data within each predefined mitigation level;
providing a content server communicatively linked to the set of baseline project data in the network-based non-transitory storage device;
providing remote access to the content server over a network in real time to a user device to allow the user device to create a new project estimate through a graphical user interface (GUI) displayed on the user device;
receiving, by the content server, a preliminary set of project data entered from the user device comprising: a square footage for the project, a number of calendar days to complete the project, and a project mitigation level selected from the set of predefined mitigations levels;
generating, by the content server, an initial project budgetary and labor estimate for the project based on the preliminary set of project data and transmitting the initial project budgetary and labor estimate to the user device for display in the GUI;
displaying on the user device via the GUI, a screen to enter additional project specific parameters to create a set of project adjustments;
receiving, by the content server, the set of project adjustments entered from the user device;
updating, via the content server:
the expected production rate based on the received set of project adjustments; and
the initial project budgetary and labor estimate according to the updated expected production rate to generate a final project budgetary and labor estimate; and
transmitting the final project budgetary and labor estimate to the user device in real time for display in the GUI.

2. A method for generating a project budget and insurance loss reserve estimation for recovery and restoration of property damage to a facility according to claim 1, further comprising saving the final project budgetary and labor estimate to the network-based non-transitory storage device.

3. A method for generating a project budget and insurance loss reserve estimation for recovery and restoration of property damage to a facility according to claim 1, further comprising generating a completed estimate bid package based on the final project budgetary and labor estimate.

4. A method for generating a project budget and insurance loss reserve estimation for recovery and restoration of property damage to a facility according to claim 3, wherein the completed estimate bid package comprises a scope of work.

5. A method for generating a project budget and insurance loss reserve estimation for recovery and restoration of property damage to a facility according to claim 4, wherein content server prompts the user device to select from a predetermined list of factors used to generate the scope of work.

6. A method for generating a project budget and insurance loss reserve estimation for recovery and restoration of property damage to a facility according to claim 1, wherein the labor estimate of the final project budgetary and labor estimate is determined according to the updated production rate, the square footage of the project, and the number of calendar days to complete the project.

7. A method for generating a project budget and insurance loss reserve estimation for recovery and restoration of property damage to a facility according to claim 1, wherein the labor estimate of the final project budgetary and labor estimate includes a breakdown of labor costs by labor type and number required.

8. A method for generating a project budget and insurance loss reserve estimation for recovery and restoration of property damage to a facility according to claim 1, wherein the set of project adjustments comprises at least one of: a facility type for the property, wall height for the facility, a level of water damage, a level of smoke damage, a level of mold damage, a number of floors for the facility, and a level of document preservation.

9. A method for generating a project budget and insurance loss reserve estimation for recovery and restoration of property damage to a facility according to claim 8, wherein:
the content server displays to the GUI a selection box for each available project adjustment;
the graphical user interface allows a user to edit each selection box and transmit any changes back to the content server; and
the content service updates the initial project budgetary and labor estimate according to any changes received from the user device.

10. An internet-based budget and reserve estimation system for recovery and restoration of a facility with property damage accessible by a user device connected to the internet via a network, comprising:
a network-based non-transitory storage device storing a set of project data, wherein:
the set of baseline project data includes a set of predefined mitigation levels corresponding to an amount of restoration required due to a type and extent of suffered damage; and
each predefined mitigation level corresponds to an expected production rate of a laborer based on historical data within each predefined mitigation level;
a content server communicatively linked to the set of project data in the network-based non-transitory storage device, wherein the content server is configured to:
be accessible to the user device over the network and display a graphic user interface (GUI) on the user device;
receive a preliminary set of project data entered from the user device via the graphic user interface, wherein the preliminary set of project data comprises: a square footage for the project, a number of calendar days to complete the project, and a project mitigation level selected from the set of predefined mitigations levels;
generate an initial project budgetary and labor estimate for the project based on the preliminary set of project data; and
transmit the initial project budgetary and labor estimate to the user device for display in the GUI;
display on the user device, via the GUI, a screen to enter additional project specific parameters to create a set of project adjustments;
receive the set of project adjustments entered from the user device;
update:
the expected production rate based on the received set of project adjustments; and
the initial project budgetary and labor estimate according to the updated expected production rate to generate a final project budgetary and labor estimate; and
transmit the final project budgetary and labor estimate to the user device in real time for display in the GUI.

11. An internet-based budget and reserve estimation system for recovery and restoration of a facility with property damage according to claim 10, wherein the content server is configured to save the final project budgetary and labor estimate to the network-based non-transitory storage device.

12. An internet-based budget and reserve estimation system for recovery and restoration of a facility with property damage according to claim 10, wherein the content server is configured to generate a completed estimate bid package based on the final project budgetary and labor estimate.

13. An internet-based budget and reserve estimation system for recovery and restoration of a facility with property damage according to claim 12, wherein the completed estimate bid package comprises a scope of work.

14. An internet-based budget and reserve estimation system for recovery and restoration of a facility with facility with property damage according to claim 13, wherein content server prompts the user device to select from a predetermined list of factors used to generate the scope of work.

15. An internet-based budget and reserve estimation system for recovery and restoration of a facility with property damage according to claim 10, wherein the labor estimate of the final project budgetary and labor estimate is determined according to the updated production rate, the square footage of the project, and the number of calendar days to complete the project.

16. An internet-based budget and reserve estimation system for recovery and restoration of a facility with property damage according to claim 10, wherein the labor estimate of the final project budgetary and labor estimate includes a breakdown of labor costs by labor type and number required.

17. An internet-based budget and reserve estimation system for recovery and restoration of a facility with property damage according to claim 10, wherein the set of project adjustments comprises at least one of: a facility type for the property, wall height for the facility, a level of water damage, a level of smoke damage, a level of mold damage, a number of floors for the facility, and a level of document preservation.

18. An internet-based budget and reserve estimation system for recovery and restoration of a facility with property damage according to claim 17, wherein:
the content server displays to the GUI a selection box for each available project adjustment;
the graphical user interface allows a user to edit each selection box and transmit any changes back to the content server; and
the content service updates the initial project budgetary and labor estimate according to any changes received from the user device.
